(19) United States
(12) Patent Application Publication
(10) Pub. No.: US 2026/0220626 A1
(43) Pub. Date: Jul. 30, 2026

(54) RETAIL FUELING ENVIRONMENT HAVING FIBER OPTIC DATA CONNECTIVITY

(71) Applicant: Gilbarco Inc., Greensboro, NC (US)

(72) Inventor: Edward A. Payne, Kemersville, NC (US)

(21) Appl. No.: 19/459,896

(22) Filed: Jan. 26, 2026

Related U.S. Application Data
(60) Provisional application No. 63/749,542, filed on Jan. 25, 2025.

(51) Int. Cl. G06Q 20/34

(52) U.S. Cl. CPC G06Q 20/34

(57) ABSTRACT

The present invention provides a fiber-optical data connectivity system for use in retail fueling environments. The system replaces traditional copper data layers with optical fibers, enabling longer transmission distances, reducing costs, and eliminating bandwidth degradation. Key features include photo emitters and receivers at each fuel dispenser, Ethernet PHY and SFP modules for converting electrical signals to optical signals, and the ability to deploy in either star or daisy-chain topologies. The invention allows for retrofitting and future scalability in hazardous environments, providing higher bandwidth and supporting advanced data services.

### CROSS-REFERENCE TO A RELATED APPLICATION

This application is based upon and claims the benefit of provisional application Ser. No. 63/749,542, filed Jan. 25, 2025, incorporated fully herein by reference for all purposes.

### FIELD

The present invention relates to retail fueling environments having a plurality of fuel dispensers in a forecourt region outside of a convenience store or the like. Embodiments of the present invention address the limitations of copper-based physical data layers in such environments by providing a robust, scalable, and high-bandwidth fiber-optic communication network. Specifically, fiber-optic connectivity solutions according to the present invention provide various advantages over the prior art.

### BACKGROUND

The conventional communication infrastructure within retail fueling environments heavily relies on copper wiring for data transfer between the forecourt (where fuel dispensers are located) and the backroom or control center. Copper wiring has been in use for decades, and while functional, it presents significant limitations when addressing modern data demands, particularly in a connected and data-driven world. Several key limitations are inherent in this setup:
Copper-based data transmission systems, such as those using RS-232, RS-485, and Current-Loop as their physical layer, operate at low data rates that are inadequate for the high-speed data requirements of modern retail systems. To address high-speed data requirements, Ethernet is being more prevalently used.
Copper cabling, such as Ethernet over twisted pair (e.g., 10BASE-T, 100BASE-T, 1000BASE-T), is typically limited to a physical range of 100 meters. To cover greater distances, additional equipment like modems or repeaters are required, which increases the complexity and cost of installation. In larger retail fueling environments, particularly those with extended forecourt layouts, this limitation becomes a significant drawback. Moreover, backroom modems are often connected to multiple dispensers forcing them to share bandwidth. As the number of connected dispensers increases, the available bandwidth per dispenser decreases, resulting in latency and poor performance, especially in applications involving real-time data transfer, such as media delivery or customer-facing services.
Retail fueling environments are considered hazardous due to the presence of combustible fuel vapors. To comply with safety standards, including UL (Underwriters Laboratories) and ATEX (Atmosphères Explosibles), copper wiring for data transmission must be installed in separate conduits from power lines, increasing both installation and maintenance costs. Furthermore, vapor-blocked conduits must be used to prevent the migration of vapors through the wiring infrastructure, further driving up costs.
Real-time data services, such as media delivery or transactional data transfers, often face latency and packet loss in copper-based systems. To address this, fuel dispensers are forced to cache data locally, requiring additional memory and hardware, which in turn increases the cost of the dispensers. However, caching cannot fully compensate for the limitations of low-bandwidth communication, and it prevents dispensers from delivering real-time data services like targeted advertising or live video communication.
Copper wiring requires stringent safety measures in retail fueling environments. Separate conduits for high-energy power lines and low-energy data lines must be installed to comply with safety standards for explosive environments. This not only adds complexity but also increases the cost and space required for installation, particularly in retrofitting older fuel stations.

Several solutions have been proposed and implemented to mitigate the limitations of copper-based data communication systems, but these have their own limitations:
Traditional forecourt communication systems often rely on modems for data transfer. These modems communicate over copper wiring with each fuel dispenser, aggregating data from multiple dispensers. However, this solution suffers from bandwidth degradation as more dispensers are added, and the communication speed is far below modern standards. Most of these systems are based on 1990s-era technology, which has not evolved significantly to meet current data demands.

In an attempt to extend the distance limitations of copper, some systems incorporate copper-to-fiber media converters, allowing data to be transmitted over longer distances using fiber optics, but returning to copper for the last segment of the connection to each dispenser. While this approach extends distance, it retains many of the limitations of copper at the dispenser, including bandwidth constraints and the need for complex conduit infrastructure.

Wireless systems, such as those based on Wi-Fi or other wireless protocols, have also been proposed as a solution to the cabling limitations. While wireless communication eliminates the need for copper wiring, it introduces issues related to signal reliability, interference, and security, particularly in outdoor environments like fueling stations where line-of-sight between radio devices may be randomly blocked by vehicles or unavailable. Additionally, wireless systems still face challenges in terms of bandwidth and latency, especially as the number of connected dispensers increases.

Outside of retail fueling environments, fiber-optic communication is widely regarded as the state of the art for high-speed, long-distance data transmission. Fiber optics are commonly used in data centers, telecommunications, and industrial automation because of their advantages over copper, including:
High Bandwidth: Fiber optics can support extremely high data transfer rates, making them ideal for real-time communication and media delivery.
Longer Transmission Distances: Fiber-optic cables can transmit data over several kilometers without the need for repeaters or mid-point amplifiers, far exceeding the distance limitations of copper.
Electromagnetic Interference Immunity: Unlike copper, fiber-optic cables are immune to electromagnetic interference (EMI), making them more reliable in environments with electrical noise.

In the information technology (IT) domain, fiber optics have become the preferred solution for connecting data centers, high-performance computing clusters, and long-distance telecommunications infrastructure. However, the application of fiber-optic communication in hazardous retail environments, such as fueling stations, has been limited, due in part to the industry's reliance on outdated copper-based systems and concerns about the cost and complexity of adopting new technologies.

### SUMMARY

The present system relates to a fiber-optical data connectivity system designed for retail fueling environments, addressing the limitations of copper-based communication. By replacing copper with fiber-optic cables, the system eliminates bandwidth degradation, reduces installation and maintenance costs, and enables longer-distance communication (greater than 1 km).

Furthermore, adoption and application of current information technology connectivity art within a retail fueling environment, furthermore facilitating:
Elimination of bandwidth sharing on a forecourt presently degraded by a function of the number of fuel dispensers supported;
Reduction of fuel dispenser memory requirements and associated cost required to cache media or other packetized data presently undeliverable in real-time. As corollary, the enablement of ad-hoc packetized real-time data customized for customer and/or other variables;
Elimination of the cost for forecourt dispensers and backroom for the extension of copper physical layers beyond current art limitations, this typically being 100 meters, with fiber exceeding >1 km without intermediate or repeating device;
Elimination of the cost associated with customer-site dual vapor-sealed conduit infrastructure presently requiring physically separate low-energy (data, intercom) and high-energy (power, STP control) runs;
To allow for direct earthen burial of data fiber if desired, this including horizontal directional drilling beneath exiting concrete forecourt surfaces, or the inclusion within existing conduit without regard to energy levels preexisting, these methods useful for retrofitting and emerging markets. With dual interfaces, the fiber may be daisy-chained to simplify installation and construction cost; and
Facilitation of future dispenser innovations rendered by reducing bandwidth restrictions and other variables such as limitations constrained upon the number of dispensers for a given scale or forecourt topology.

According to one aspect, the present invention provides a fueling environment comprising a plurality of fuel dispensers spaced apart in a forecourt. Backroom components in operative communication with the fuel dispensers are also provided. The backroom components receive payment information from each of the dispensers and responsively provide transaction authorization information. Each of the fuel dispensers has circuitry operative to control operation of one or more hydraulic components, receive the payment information from a card reader at the dispenser and pass it to the backroom components, and receive the transaction authorization from the backroom components. Communication interfaces are associated with the backroom components and respective of the fuel dispensers, the communication interfaces each comprising a fiber optic transceiver. Fiber optic cable is located under the forecourt, the fiber optic cable providing signal communication between the backroom components and the fuel dispensers.

According to some exemplary embodiment, the fiber optic cable is connected between the backroom components and the fuel dispensers in one of a star topology and a daisy chain topology. For example, the fiber optic cable may comprise a pair of optical fibers providing signal transmission in opposite directions. Alternatively, the fiber optic cable may comprise an optical fiber providing signal transmission in both directions.

According to some exemplary embodiments, the communication interfaces may each include a serializer-deserializer module.

A further aspect of the present invention provides a fueling environment comprising a plurality of fuel dispensers spaced apart in a forecourt. Backroom components in operative communication with the fuel dispensers are also provided. The backroom components receive payment information from each of the dispensers and responsively provide transaction authorization information. Each of the fuel dispensers has circuitry operative to control operation of one or more hydraulic components, receive the payment information from a card reader at the dispenser and pass it to the backroom components, and receive the transaction authorization from the backroom components. Conduit in which electrical wiring is contained to power the fuel dispensers is located under the forecourt. Communication interfaces are associated with the backroom components and respective of the fuel dispensers, the communication interfaces each comprising a fiber optic transceiver. Fiber optic cable is located in the conduit with the electrical wiring, the fiber optic cable providing signal communication between the backroom components and the fuel dispensers. The fiber optic cable is connected between the backroom components and the fuel dispensers in one of a star topology and a daisy chain topology.

A still further aspect of the present invention provides a fueling environment comprising a plurality of fuel dispensers spaced apart in a forecourt. Backroom components in operative communication with the fuel dispensers are also provided. The backroom components receive payment information from each of the dispensers and responsively provide transaction authorization information. Each of the fuel dispensers has circuitry operative to control operation of one or more hydraulic components, receive the payment information from a card reader at the dispenser and pass it to the backroom components, and receive the transaction authorization from the backroom components. Conduit in which electrical wiring is contained to power the fuel dispensers is located under the forecourt. Communication interfaces are associated with the backroom components and respective of the fuel dispensers, the communication interfaces each comprising a fiber optic transceiver. Fiber optic cable is located under the forecourt, the fiber optic cable providing signal communication between the backroom components and the fuel dispensers, the fiber optic cable being located in the ground beneath the forecourt without a rigid conduit. The fiber optic cable is connected between the backroom components and the fuel dispensers in one of a star topology and a daisy chain topology.

Those skilled in the art will appreciate the scope of the present invention and realize additional aspects thereof after reading the following detailed description of preferred embodiments in association with the accompanying drawing figures.

### BRIEF DESCRIPTION OF THE DRAWINGS

For a more complete understanding of the present disclosure and its advantages, reference is now made to the following description taken in conjunction with the accompanying drawings, in which like reference numbers represent like parts:

FIG. 1 is a diagrammatic representation of a fueling environment with a star connection topology in which aspects of the present invention may be utilized.

FIG. 2 is a diagrammatic representation of a fueling environment with a daisy chain topology in which aspects of the present invention may be utilized.

FIG. 3 diagrammatically illustrates certain aspects of one of the fuel dispensers located at a fueling site of FIG. 1 or FIG. 2.

FIG. 4 diagrammatically shows fuel dispenser connectivity according to the prior art in which data and mains power to the dispenser are provided by electrical wiring in separate conduits.

FIG. 5 diagrammatically shows fuel dispenser connectivity according to an embodiment of the present invention in which data and mains power to the dispenser are provided by fiber optic cable and electrical wiring in the same conduit.

FIG. 6 diagrammatically shows fuel dispenser connectivity according to an embodiment of the present invention in which mains power wiring to the dispenser is provided in a conduit and fiber optic cable for data is buried in the earth.

FIG. 7A shows a pair of optical fibers respectively dedicated for transmission and reception in different directions between an end point and the dispenser.

FIG. 7B shows a single optical fiber providing transmission and reception in both directions between an end point and the dispenser.

FIG. 8 is a diagram showing the connection between an Ethernet PHY with dual SerDes interfaces and SFP (Small Form Factor Plug-in) module interfaces.

FIG. 9 is an exemplary optical SFP transceiver module that may be used in embodiments of the present invention.

FIG. 10 is an exemplary SFP RJ45 transceiver module that may be used in embodiments of the present invention.

### DETAILED DESCRIPTION

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the present disclosure including the appended claims and their equivalents.

The new and novel system and method described herein provides a fiber-optic data communication system tailored for use in retail fueling environments, specifically addressing the challenges associated with copper-based data transmission layers. Copper wiring traditionally used for data transfer between fuel dispensers and the backroom is replaced with optical fiber technology. This fiber-optic system not only eliminates the limitations of copper but also introduces greater bandwidth, reduced latency, and enhanced scalability for future innovations.

The system and method typically includes: a photo emitter and photo receiver pair at dispenser or other endpoint; a conjugate photo emitter and photo receiver pair at backroom or other endpoint, the other endpoint further not limited to being at least one second dispenser; an optical fiber operating either in single-mode or multimode, either dual in construct to optically separate transmit and receive data, or by optical frequency difference having transmit and receive data separated upon a single fiber, or by time-division having transmit and receive data separated upon a single fiber, or combination thereof of forementioned methodologies

A particular advantage of the presently described system and method is the elimination of copper wiring from the forecourt data communication layer, addressing the bandwidth, distance, and cost limitations inherent in existing systems.

Another advantage is the introduction of fiber-optic connectivity to the retail fueling industry, leveraging the high bandwidth, long-distance transmission, and safety benefits of fiber optics.

Still another advantage is the simplified installation and reduced costs afforded by allowing fiber-optic cables to be directly buried beneath forecourt surfaces, reducing the need for separate conduit systems for data and power lines.

Yet another advantage is the enablement of future innovations, such as real-time data services, targeted advertising, and two-way video communication, by providing a robust, scalable data infrastructure that can support new services and devices without being limited by the constraints of copper wiring.

The invention thus offers a transformative approach to data communication within retail fueling environments, addressing the limitations of prior art while adopting the state-of-the-art capabilities of fiber-optic technology.

Fiber-optic cables can be directly buried or installed using horizontal directional drilling under existing infrastructure (e.g., concrete forecourts), significantly reducing installation costs and time. This design is particularly advantageous for retrofitting older fueling environments and deploying new systems in hazardous locations where safety and compliance with standards such as UL and ATEX are critical.

The system leverages a combination of photo emitters and photo receivers at both the backroom (central node) and the fuel dispenser endpoints. These components transmit and receive data optically via single-mode or multimode fibers, with several possible data transmission schemes, including frequency separation, time-division multiplexing, or physical separation on dual fibers.

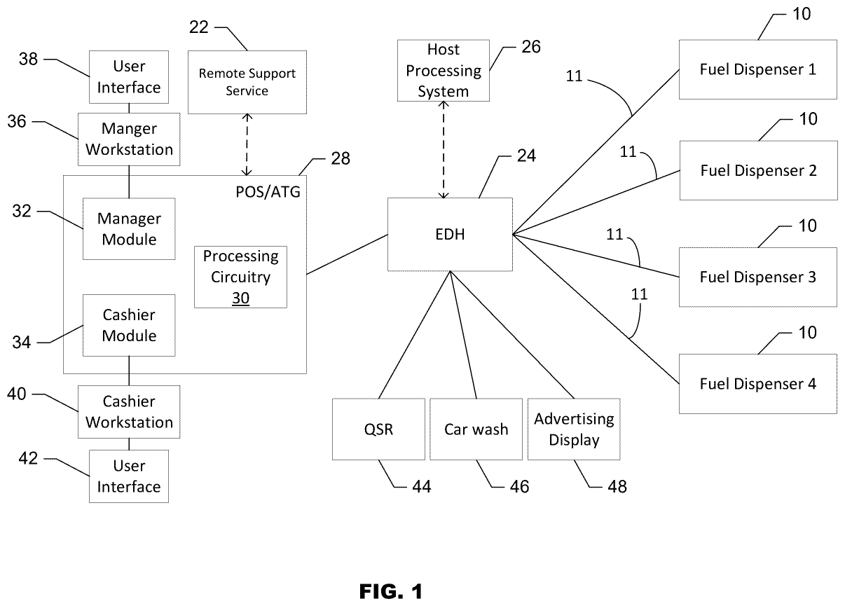

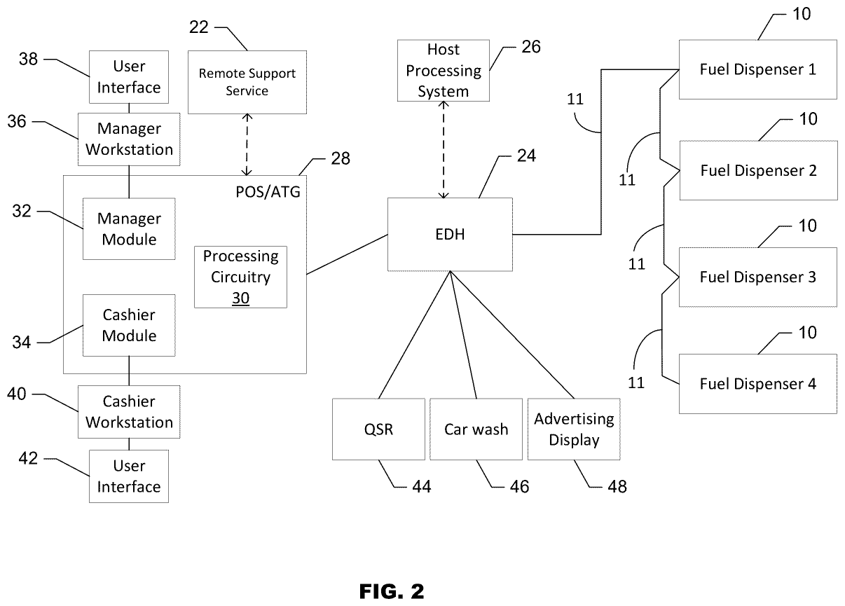

Referring now to FIGS. 1 and 2, certain details are shown regarding a service station or fueling environment that may be improved according to the present invention. Although embodiments are contemplated in which the electronic payment server is incorporated into or is in direct communication a point of sale (POS) system in the backroom (e.g., within a convenience store, or “C-store”), the illustrated embodiment utilizes an enhanced dispenser hub (EDH) 24 similar to that shown and described in U.S. Pat. No. 8,438,064 (incorporated fully herein by reference for all purposes). EDH 24 includes an electronic payment server that allows processing of payment card information. In particular, credit (or debit) card information from the fuel dispensers 10 and any in-store card readers is fed to EDH 24, which seeks approval from a remote host processing system 26 via a suitable off-site communication (e.g., the cloud).

The POS and/or the automatic tank gauge (ATG) (indicated collectively at 28) include appropriate processing circuitry 30. In the case of a POS, processing circuitry 30 executes several software modules including manager workstation module 32 and cashier workstation module 34. When executed, manager workstation module 32 displays a graphical user interface (GUI) on manager workstation 36 that allows the owner, operator, or manager of the service station (user) to set various fueling and other options. Manager workstation module 36 is also adapted to provide various POS capabilities, including the ability to conduct transactions for items offered for sale by the fueling station. Toward this end, manager workstation 36 includes a suitable user interface 38, such as a touchscreen display and may further include one or more speakers. As one skilled in art will appreciate, the manager workstation 36 may be incorporated into the same hardware as the POS.

Similarly, cashier workstation module 34 provides the station's cashier, clerk, or employee the means necessary to effect a transaction for one or more items or services offered by the fueling station. Cashier workstation module 34 communicates with the hardware of cashier workstation 40, which includes a user interface 42.

Additionally, the EDH 24 and/or the POS may be in communication with a quick service restaurant (QSR) 44, a car wash 46, and/or a separate advertising display 48. The EDH 24 and/or the POS may process orders and payments for the QSR 44 and car wash 46. The EDH 24 and/or the POS may also control the display of one or more advertising displays 48.

The fueling site may also communicate with the remote support service 22, as necessary or desired. This may be initiated by users needing assistance or automatically based on conditions occurring at the fueling site.

In the embodiment of FIG. 1, the fuel dispensers communicate with EDH and/or POS/ATG 28 in a star-connected topology via respective fiber optic cables 11 (which may each comprise a fiber pair in some cases as described below). The fiber optic cables eliminate multiple disadvantages of traditional copper wiring as has been used for this application in the past. In FIG. 2, the fiber optic cable 11 is connected to a first fuel dispenser 10, with connections to additional dispensers being made in a daisy chain topology. A daisy chain arrangement is especially advantageous for a variety of reasons, including flexibility of easily adding more dispensers in the future or more easily upgrading an existing installation as a retrofit. The high bandwidth of fiber optic cable allows this flexibility without degradation in performance.

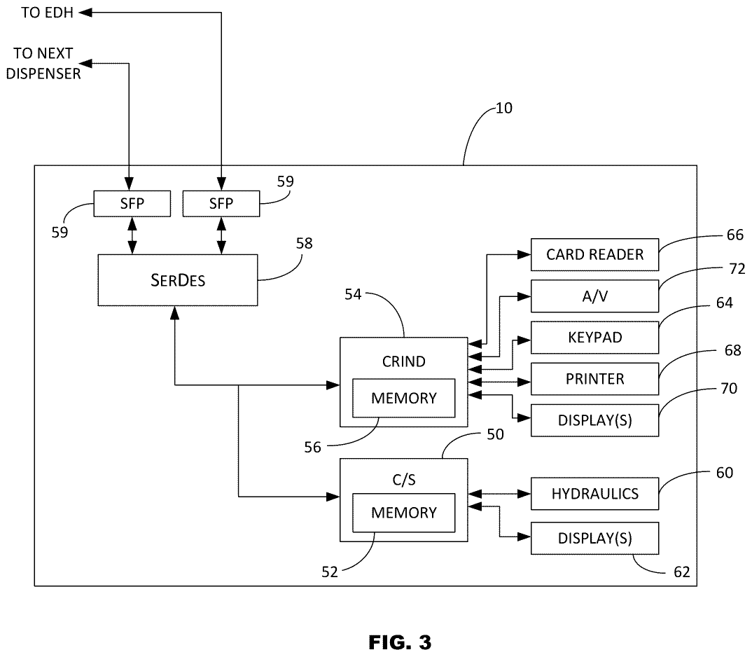

Referring now to FIG. 3, additional details regarding the various components of fuel dispenser 10 can be more easily explained. As shown, fuel dispenser 10 includes a control system 50 having an associated memory 52. Dispenser 10 may also comprise a CRIND (card reader in dispenser) module 54 and associated memory 56. Those skilled in the art are familiar with CRIND units used in fuel dispensers, but additional background information is provided in U.S. Pat. No. 4,967,366, the entirety of which is incorporated by reference herein for all purposes.

As shown, control system 50 and CRIND module 54 are in operative communication with EDH 24 via an interface. In this case, the interface includes a Serializer/Deserializer (SerDes) module 58. As one skilled in the art will appreciate, module 58 functions to convert data between serial data for transmission to or receipt from fiber optic cable to parallel data. In this case, module 58 communicates with a pair of optical fiber transceivers 59 which may preferably take the form of respective Small Form-Factor Pluggable (SFP) ports. In this case, one of the transceivers 59 communicates with the EDH (or POS/ATG 28) while the other communicates with the next dispenser 10 in the daisy chain.

Control system 50 includes the hardware and software necessary to control the hydraulic (fuel handling) components and functions of dispenser 10. Those skilled in the art are familiar with the operation of the hydraulics 60 of dispenser 10. In general, however, fuel from a source of fuel (e.g., one or more underground storage tanks, “USTs”) is pumped through a piping network into an inlet pipe. Fuel being dispensed passes through a flow meter, which is responsive to flow rate or volume. A displacement sensor, such as a pulser, is employed to generate a signal in response to fuel flow though the meter and communicate this information to control system 50. Control system 50 may also provide control signaling to a valve that may be opened and closed to permit or not permit dispensing of fuel.

Meter flow measurements from the displacement sensor are collected by control system 50. Control system 50 also typically performs calculations such as cost associated with a fuel dispensing transaction. As a dispensing transaction progresses, fuel is then delivered to a hose and through a nozzle into the customer's vehicle. Dispenser 10 typically includes a nozzle boot, which may be used to hold and retain the nozzle when not in use. The nozzle boot may include a mechanical or electronic switch in communication with control system 50 to indicate when the nozzle has been removed for a fuel dispensing request and when the nozzle has been replaced, signifying the end of a fueling transaction. Control system 50 may thus determine whether a transaction has been initiated or completed.

Control system 50 may further be operative to control one or more displays 62. For example, a transaction price total display may present customers with the price for fuel that is dispensed. A transaction volume total display may be used to present customers with the measurement of fuel dispensed in units of gallons or liters. Finally, price per unit (PPU) displays may be provided to show the price per unit of fuel dispensed in either gallons or liters, depending on the programming of dispenser 10.

CRIND module 54 includes the hardware and software necessary to support payment processing and peripheral interfaces at dispenser 10. In this regard, CRIND module 54 may be in operative communication with several input devices. For example, a PIN pad 64 is typically used for entry of a PIN if the customer is using a debit card for payment of fuel or other goods or services. CRIND module 54 may also be in operative communication with a card reader 66 for accepting credit, debit, or other magnetic stripe or chip cards for payment. Additionally, card reader 66 may accept loyalty or program-specific cards as is well known. Further, CRIND module 54 may be in operative communication with other payment or transactional devices such as a receipt printer 68.

One or more display(s) 70 may be used to display information, such as transaction-related prompts and advertising, to the customer. The customer may use soft keys to respond to information requests presented to the user via a display 70. In some embodiments, however, a touch screen may be used for display 70.

Audio/video electronics 72 are adapted to interface with the CRIND module 54 and/or an auxiliary audio/video source to provide advertising, merchandising, and multimedia presentations to a customer in addition to basic transaction functions. The media may be provided, for example, by a media server incorporated into POS/ATG 28. The user interface provided by the dispenser may also allow customers to purchase goods and services other than fuel at the dispenser. For example, the customer may purchase a car wash and/or order food from the store while fueling a vehicle.

In operation, a user positions a vehicle adjacent to one of dispensers 10 and uses the dispenser to refuel the vehicle. For payment, the user typically inserts and removes a payment card from a card information reader at the dispenser. The card information reader reads the information on the payment card and transmits the information to EDH 24 (in this embodiment). EDH 24 provides the payment information to the appropriate host processing system 26 operated by the financial institution associated with the user's payment card. The financial institution either validates or denies the transaction and transmits such a response to EDH 24. This may include transmitting to dispenser 10 a request that the user provide another payment card if the transaction is denied.

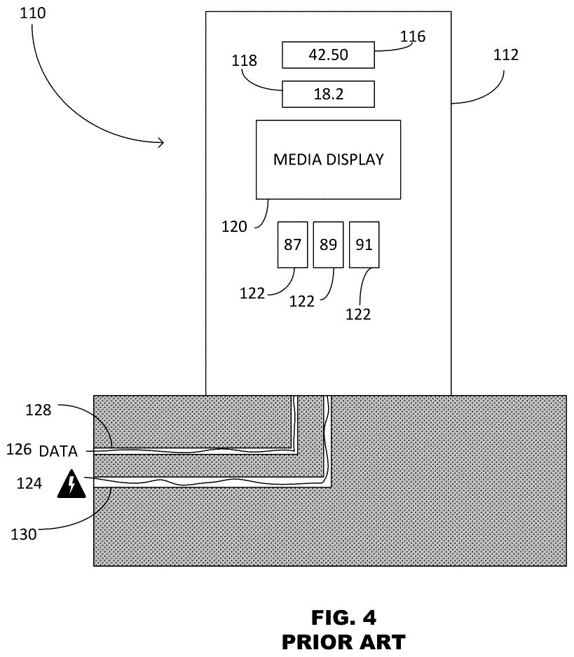

FIG. 4 illustrates a fuel dispenser 110 in accordance with the prior art. Dispenser 110 has a housing 112 containing various electronic and hydraulic components. A total display 116 shows the total price of the dispensed fuel. A volume display 118 shows the volume of fuel dispensed (e.g., in gallons or liters). A media display 120 provides instructions for the fueling transaction and may also provide advertising or other media during idle times. As noted above, this media was often cached at the dispenser itself to account for latency imposed by the limited bandwidth of traditional copper wiring. Fuel octane or type selector buttons 122 are also typically provided.

Due to the flammable nature of traditional fuels such as gasoline, higher energy electrical wiring 124 for powering the dispenser was required to be kept separate from lower energy electrical wiring 126 used for data signals to and from the dispenser (such as signals related to authorization of the fueling transaction and media presentations). In particular, the respective sets of wiring 124 and 126 were contained in separate vapor sealed conduits, designated 128 and 130, respectively. The requirement to have such separate conduits has made installation and upgrade of fuel dispensers especially difficult.

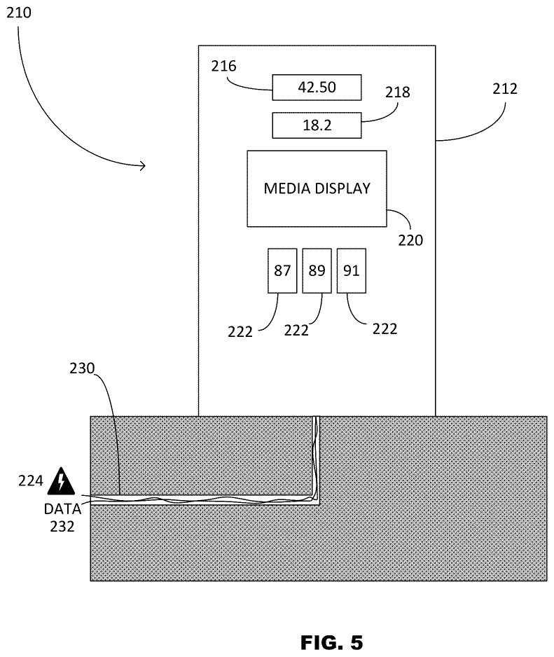

FIG. 5 illustrates a fuel dispenser 210 in accordance with an embodiment of the present invention. Similar elements to those of FIG. 4 will be designated by a reference number augmented by one hundred (e.g., dispenser 210 instead of dispenser 110). In this case, however, a single conduit 230 is provided containing both higher energy wiring 224 for powering the dispenser and a fiber optic cable 232 in lieu of lower energy data wiring 126. Fiber optic cable 232 may advantageously be located alongside higher energy wiring 224. The need to cache media in the dispenser because of the bandwidth limitations of copper wiring is eliminated.

FIG. 6 illustrates a fuel dispenser 310 in accordance with an embodiment of the present invention. Similar elements to those of FIG. 5 will be designated by a reference number augmented by one hundred (i.e., dispenser 310 instead of dispenser 210). A single conduit 330 contains higher energy wiring 324 for powering the dispenser. A fiber optic cable 332 in lieu of lower energy data wiring 126 is advantageously simply located in the ground without a separate rigid conduit. (Note, any jacket surrounding the fiber optic cable is not considered “conduit” as that term is used herein.)

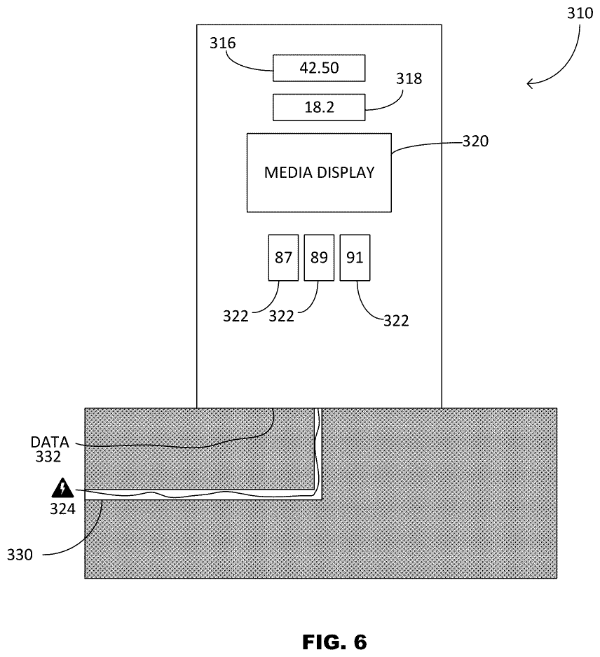

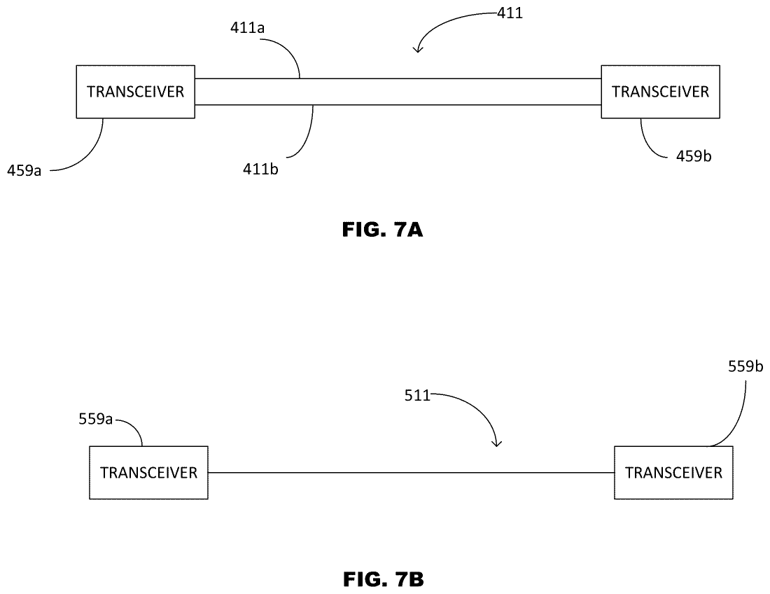

Referring now to FIGS. 7A and 7B, alternative fiber optic cables 411 and 511 are illustrated, either of which may be used a fiber optic cable 11 in various embodiments. In FIG. 7A, a pair of individual optical fibers 411a and 411b extend between first and second transceivers 459a and 459b (analogous to transceivers 59 of FIG. 3). Transceiver 459a will be located at an end point (e.g., the back room or a previous dispenser in the chain) whereas transceiver 459b is in the current dispenser. Signals flow through optical fibers 411a and 411b in opposite directions (e.g., 411a toward transceiver 459b and 411b away from transceiver 459b).

In FIG. 7B, a dual mode optical fiber passes signals in both directions between transceivers 559a and 559b.

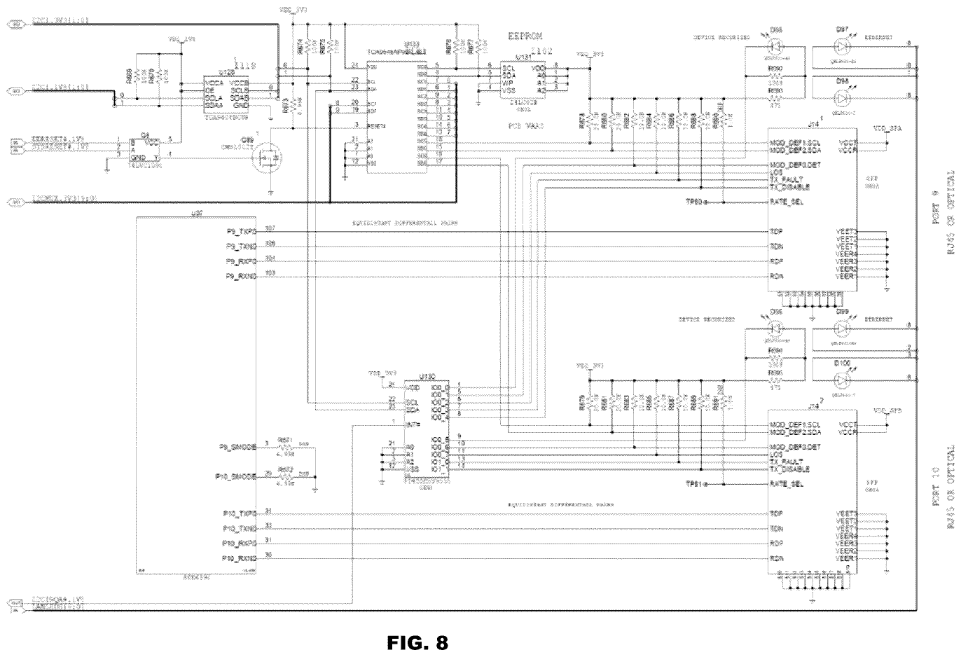

Turning now to FIG. 8, in an exemplary embodiment, there is shown an Ethernet PHY (and here, further serving as an Ethernet switch) U37 having dual SerDes interfaces, each SerDes interface comprising one transmit differential pair, and one receive differential pair.

It is to be understood that although two SerDes interfaces are shown in FIG. 8, the invention is not limited to the dual embodiment depicted and may comprise a single SerDes interface or greater than two SerDes interfaces. Note that SerDes carries its data clock as an encoded composite, therefore the four conductors associated with each port's full duplex data transfer methodology are sufficient.

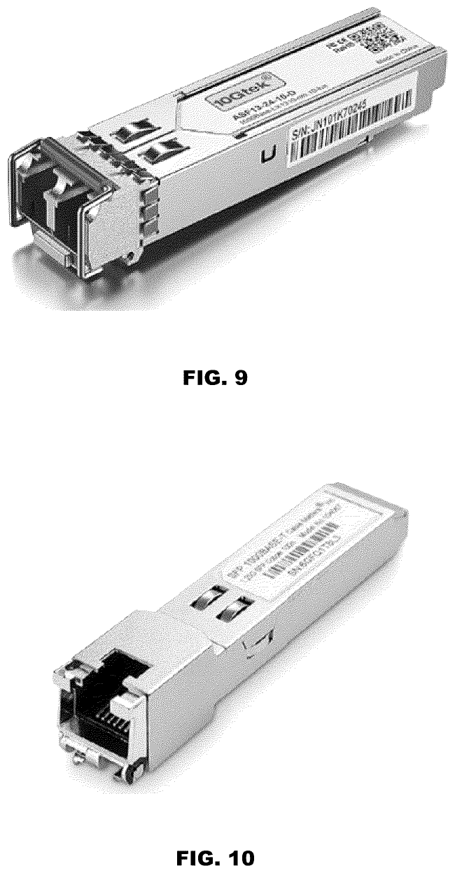

The SerDes transmit differential pairs require capacitive (AC) coupling. By convention this is the responsibility of an SFP module (FIG. 9 shows an exemplary optical SFP module). However they will often appear in schematics between PHY and SFP, and their absence or presence is not a limitation as shown herein.

With capacitive coupling presumed satisfied, the SerDes transmit and receive differential pairs are summarily connected to two discreet SFP module interfaces J14. This completes the data channels necessary to effect PHY to SFP interconnection.

With data transfer methodology now described, by convention additional functions are provided by the SFP module. Some SFP module statuses are communicated to the local host by discreet bits. For example, Loss of Signal (LOS) and Transmit Fault (loss of laser diode). SFP module emitter enablement and disablement (without respect to data traffic) may be performed by toggling Transmit Disable. It is desirous to prevent unnecessary laser light emission as a default condition at power up and later as a function of PCB state to prevent exposure of laser light to personnel during manufacturing and field servicing.

SFP modules nominally contain an EEPROM of 24LC02 equivalency. This EEPROM further contains data including, but not limited to, module parameters and manufacturer identification. This data is read using an I2C interface with the local host CPU serving as I2C master. Since multiple SFP modules are supported, furthermore an additional 24LC02 is present within this example serving to contain the host PCB's manufacturing data and other parameters in a similar fashion, all 24LC02 devices having an identical I2C address, here hexadecimal 0x0a, therefore a multiplexer, designator U133 precludes I2C address collision.

Recognizing that SFP modules are generic commodities and widely substitutable, LEDs D95 and D96 are shown as controlled by the local host CPU to affirm that only an approved and recognized SFP module has been seated. This is done by the reading and validation of the SFP module's EEPROM contents.

LED pairs D97 and D98, and LED pairs D99 and D100 correspond to Ethernet signal status in a similar manner as would be nominal if copper were being used.

RJ45 SFP modules may be readily substituted versus optical for the expansion of copper Ethernet connections (FIG. 10).

It should be understood that either “Star” or “Daisy Chain/Cascaded” fiber interconnection topologies or a combination of both topologies may be used. Whereas a “Star” topology will provide maximin backroom (or other endpoint) to dispenser (or other endpoint) bandwidth, a “Daisy Chain” topology facilitates direct burial including horizonal boring for preexisting sites beneath concrete and/or for adding high speed connectivity to emerging markets.

In a particular embodiment, U37 is a VLAN switch. In addition to other benefits such as virtualizing ports, in a “Daisy Chain” topology a VLAN would further serve to eliminate fiber pass-through traffic from impinging upon the local CPU's MII.

It should be noted that the foregoing embodiments are by way of example and not limitation. Several variations may be implemented, including alternative data transmission methods. While the preferred embodiment uses SerDes and SFP modules, other data transmission standards may be employed, such as Copper-to-Fiber media converters for environments where some legacy copper infrastructure remains.

Another variation includes custom optical modulation schemes wherein in addition to standard frequency-or time-division multiplexing, the system may use custom modulation techniques, such as Non-Return-to-Zero (NRZ) encoding, to optimize data transmission for specific operational environments.

Still another variation is extended distance support. Depending on the specific fiber type used (single-mode vs. multimode), the system can support transmission distances ranging from a few hundred meters to several kilometers without the need for signal repeaters or amplifiers.

Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A fueling environment comprising:
a plurality of fuel dispensers spaced apart in a forecourt;
backroom components in operative communication with the fuel dispensers to receive payment information from each of the dispensers and responsively provide transaction authorization information;
each of the fuel dispensers having circuitry operative to control operation of one or more hydraulic components, receive the payment information from a card reader at the dispenser and pass it to the backroom components, and receive the transaction authorization from the backroom components;
communication interfaces are associated with the backroom components and respective of the fuel dispensers, the communication interfaces each comprising a fiber optic transceiver; and
fiber optic cable located under the forecourt, the fiber optic cable providing signal communication between the backroom components and the fuel dispensers.

2. A fueling environment as set forth in claim 1, wherein the fiber optic cable is connected between the backroom components and the fuel dispensers in one of a star topology and a daisy chain topology.

3. A fueling environment as set forth in claim 2, wherein the fiber optic cable comprises a pair of optical fibers providing signal transmission in opposite directions.

4. A fueling environment as set forth in claim 2, wherein the fiber optic cable comprises an optical fiber providing signal transmission in both directions.

5. A fueling environment as set forth in claim 1, wherein the fiber optic cable is connected between the backroom components and the fuel dispensers in a star topology.

6. A fueling environment as set forth in claim 1, wherein the fiber optic cable is connected between the backroom components and the fuel dispensers in a daisy chain topology.

7. A fueling environment as set forth in claim 1, wherein the communication interfaces each include a serializer-deserializer module.

8. A fueling environment as set forth in claim 1, further comprising conduit under the forecourt in which electrical wiring is contained to power the fuel dispensers, the fiber optic cable also being located in the conduit.

9. A fueling environment as set forth in claim 1, wherein the fiber optic cable is located in the ground beneath the forecourt without a rigid conduit.

10. A fueling environment as set forth in claim 1, wherein the backroom components comprise an enhanced dispenser bub.

11. A fueling environment comprising:
a plurality of fuel dispensers spaced apart in a forecourt;
backroom components in operative communication with the fuel dispensers to receive payment information from each of the dispensers and responsively provide transaction authorization information;
each of the fuel dispensers having circuitry operative to control operation of one or more hydraulic components, receive the payment information from a card reader at the dispenser and pass it to the backroom components, and receive the transaction authorization from the backroom components;
conduit under the forecourt in which electrical wiring is contained to power the fuel dispensers;
communication interfaces are associated with the backroom components and respective of the fuel dispensers, the communication interfaces each comprising a fiber optic transceiver; and
fiber optic cable located in the conduit with the electrical wiring, the fiber optic cable providing signal communication between the backroom components and the fuel dispensers,
wherein the fiber optic cable is connected between the backroom components and the fuel dispensers in one of a star topology and a daisy chain topology.

12. A fueling environment as set forth in claim 11, wherein the communication interfaces each include a serializer-deserializer module.

13. A fueling environment comprising:
a plurality of fuel dispensers spaced apart in a forecourt;
backroom components in operative communication with the fuel dispensers to receive payment information from each of the dispensers and responsively provide transaction authorization information;
each of the fuel dispensers having circuitry operative to control operation of one or more hydraulic components, receive the payment information from a card reader at the dispenser and pass it to the backroom components, and receive the transaction authorization from the backroom components;
conduit under the forecourt in which electrical wiring is contained to power the fuel dispensers;
communication interfaces are associated with the backroom components and respective of the fuel dispensers, the communication interfaces each comprising a fiber optic transceiver; and
fiber optic cable located in the ground beneath the forecourt without a rigid conduit, the fiber optic cable providing signal communication between the backroom components and the fuel dispensers,
wherein the fiber optic cable is connected between the backroom components and the fuel dispensers in one of a star topology and a daisy chain topology.
